(19) United States
(12) Patent Application Publication
(10) Pub. No.: US 2017/0236334 A1
(43) Pub. Date: Aug. 17, 2017

(54) VIRTUAL FITTING SYSTEM, DEVICE AND METHOD

(71) Applicants: BOE TECHNOLOGY GROUP CO., LTD., Beijing (CN); BEIJING BOE MULTIMEDIA TECHNOLOGY CO., LTD., Beijing (CN)

(72) Inventors: Shuhuan YU, Beijing (CN); Junning SU, Beijing (CN); Jianting WANG, Beijing (CN); Peng CHENG, Beijing (CN); Chao ZHANG, Beijing (CN)

(73) Assignees: BOE Technology Group Co., Ltd., Beijing (CN); Beijing BOE Multimedia Technology Co., Ltd., Beijing (CN)

(21) Appl. No.: 15/518,654

(22) PCT Filed: Mar. 4, 2016
(86) PCT No.: PCT/CN2016/075647

§ 371 Date: Apr. 12, 2017

(30) Foreign Application Priority Data
Sep. 17, 2015 (CN) 201510595441.5

(51) Int. Cl. G06T 19/00; G06F 3/0482; G06F 3/16; G06F 3/041; G06F 17/30; G06F 3/0488

(52) U.S. Cl. CPC G06T 19/006; G06F 17/30277; G06F 3/0488; G06F 3/167; G06F 3/041; G06F 3/0482; G06T 2210/16

(57) ABSTRACT

A virtual fitting system, comprising: a virtual fitting device configured to provide a virtual scene where a user tries on a sample garment prototype and a sample garment; and a modification unit configured to modify, in response to a request of the user, the sample garment prototype on which the user tries to generate a sample garment that meets the requirements of the user. The virtual fitting system can implement customization of personalized garments. Also provided are a virtual fitting device and a virtual fitting method.

### TECHNICAL FIELD

Embodiments of the present disclosure relate to the display field, in particular to virtual fitting system, device and method.

### BACKGROUND

With the continuous development of society and economy, people are in pursuit for personalized costume design. As each person is different in height, weight, posture, color and aesthetic perception, in the process of designing and manufacturing personalized clothes, people need to try on clothes to observe the effect of wearing the clothes. Currently, in the process of trying on clothes, the dresser can only try on new clothes after taking off own clothes. The process requires a lot of time, manpower and garment resources. Moreover, when customers need to remotely customize clothes, the traditional processes of made-to-measure by tailors, on-scene dressing, communication and personalized customization are obviously impossible to achieve. Therefore, virtual fitting capable of satisfying the above requirements becomes a technical problem to be solved in the made-to-measure production of modern clothes.

### SUMMARY

The present disclosure provides virtual fitting system, device and method, which provide technical proposals for solving the above problems.

According to one aspect of this disclosure, a virtual fitting system is provided, comprising: a virtual fitting device configured to virtualize the scene of a dresser trying on a sample garment prototype or a sample garment; and a modification unit configured to respond to requirements of the dresser, modify the sample garment prototype which is tried on by the dresser, and generate a sample garment satisfying the requirements of the dresser.

Optionally, the system further comprising: an online communication used for online communication between the dresser and a costume designer.

Optionally, the modification unit includes: an independent modification module and a designer modification module; the independent modification module is configured to access a garment database according to an input requirement of the dresser, independently modify a selected sample garment prototype within restricted permissions, and generate a sample garment satisfying the requirement of the dresser; and the designer modification module is configured to access the garment database according to an input requirement of the costume designer, modify a sample garment prototype selected by the dresser, and generate a sample garment satisfying the requirement of the dresser.

Optionally, the garment database includes: a sample garment prototype stock configured to provide the sample garment prototype for the dresser or the costume designer; and the sample garment prototype includes clothing attributes.

Optionally, the garment database further includes: clothing attribute stocks being relevant to the sample garment prototype stock and including a style stock, a material stock, a collar stock, a sleeve stock, a hem stock, a pattern stock or a lace stock.

Optionally, the system further comprising: a sample garment stock configured to store the sample garment generated by the modification of the dresser.

Optionally, the sample garment stock is relevant to the clothing attributes stocks.

Optionally, the system further comprising: a modeling unit configured to generate the sample garment prototype.

Optionally, the system further comprising: an ordering unit configured to generate an order including the sample garment prototype or the sample garment which is tried on.

Optionally, the virtual fitting device includes a display device, in which the display device is connected with a client computer and configured to display the scene of the dresser trying on the selected garment according to input of the client computer.

Optionally, the virtual fitting device further includes a camera, a somatosensory unit and a client computer, in which both the camera and the somatosensory unit are connected with the client computer; the camera is configured to capture a body image of the dresser and transmit the body image to the client computer; the somatosensory unit is configured to sense the figure of the dresser and transmit figure information of the dresser to the client computer; and the client computer is configured to perform image processing on the body image captured by the camera, display the body image on the display device, calculate the garment size adapted to the dresser according to the figure of the dresser, match the sample garment selected by the dresser onto the body image according to the calculated garment size by image processing, and send to the display device for display.

Optionally, the display device is a touch panel and is also configured to receive a modification instruction of the dresser on the sample garment prototype or the sample garment which is tried on, and display obtained information according to the modification instruction.

Optionally, the display device is a 65 inch high definition (RD) touch panel.

Optionally, the system further comprising: a microphone, wherein the microphone is connected with the client computer and configured to input voice in the real-time communication with the costume designer.

Optionally, the virtual fitting device includes a virtual fitting mirror.

According to another aspect of this disclosure, a virtual fitting device, comprising: a display device and a client computer, wherein the display device is connected with the client computer; the client computer is configured to respond to user input and send information to the display device; and the display device is configured to display the scene of a dresser trying on a selected garment according to the information sent by the client computer.

Optionally, the device further comprising: a camera and a somatosensory unit, wherein both the camera and the somatosensory unit are connected with the client computer; the camera is configured to capture a body image of the dresser and transmit the body image to the client computer; the somatosensory unit is configured to sense the figure of the dresser and transmit figure information of the dresser to the client computer; and the client computer is configured to perform image processing on the body image captured by the camera, display the body image on the display device, calculate the garment size adapted to the dresser according to the figure of the dresser, match the sample garment selected by the dresser onto the body image according to the calculated garment size by image processing, and send obtained information to the display device for display.

According to another aspect of this disclosure, a remote virtual fitting method, comprising: allowing a dresser to try on clothes on front of a virtual fitting mirror and select a favorite sample garment prototype; and contacting a costume designer to modify or independently modifying until the dresser is satisfied with the fitting effect, if the dresser is not satisfied with the details of the sample garment prototype which is selected and tried on currently.

Optionally, the step of contacting the costume designer to modify or independently modifying until the dresser is satisfied with the fitting effect, if the dresser is not satisfied with the details of the sample garment prototype which is selected and tried on currently includes: if the costume designer is not online or the dresser selects independent modification, allowing the dresser to modify the attributes of the sample garment prototype which is selected and tried on currently within restricted permissions, until the dresser is satisfied with the fitting effect; and if the costume designer is online and the dresser does not select independent modification, allowing the dresser to directly provide requirements to the costume designer by online communication, and allowing the costume designer to modify the attributes of the sample garment prototype which is tried on currently, until the dresser is satisfied with the fitting effect.

Optionally, the method further comprising: generating an order including the attributes of the sample garment prototype or the sample garment which is tried on, if the dresser is satisfied with the sample garment prototype or the sample garment which is selected and tried on currently.

### BRIEF DESCRIPTION OF THE DRAWINGS

In order to make the embodiments of the disclosure apparent, the drawings related to the embodiments of the disclosure will be described briefly. Apparently, the described embodiments are just a part of the embodiments of the disclosure. For those skilled in the art, he or she can obtain other figure(s) according to these figures, without any inventive work.

FIG. 1 is a schematic structural view of a virtual fitting mirror provided by a first embodiment of the present disclosure;

FIG. 2a is a structural block diagram of a virtual fitting system provided by a second embodiment of the present disclosure;

FIG. 2b is another structural block diagram of the virtual fitting system provided by the second embodiment of the present disclosure;

FIG. 3 is a flowchart illustrating the communication between a dresser and a costume designer in the second embodiment of the present disclosure; and

FIG. 4 is a flowchart illustrating the process of modifying clothing attributes in the second embodiment of the present disclosure.

### REFERENCE NUMERALS OF THE ACCOMPANYING DRAWINGS

10—client computer, 11—display, 12—camera, 13—somatosensory controller,
111—touch panel, 121—HD camera, 20—cloud server, 21—garment database,
30—costume designer terminal; 100—virtual fitting device; 200—modification unit; 210—independent modification module;
220—designer modification module; 300—online communication unit; 400—sample garment stock; 500—modeling unit; 600—ordering unit; 700—microphone.

### DETAILED DESCRIPTION

Clear and complete description will be given below to the technical proposals in the embodiments of the present disclosure with reference to the accompanying drawings in the embodiments of the present disclosure. Obviously, the embodiments described are only partial embodiments of the present disclosure and not all the embodiments.

### First Embodiment

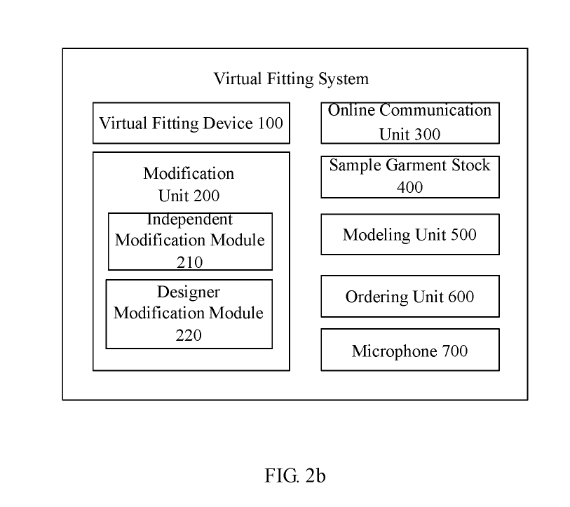

The embodiment of the present disclosure provides a virtual fitting system. As illustrated in FIG. 2b, the system comprises: a virtual fitting device 100 and a modification unit 200. The virtual fitting device, for instance, may be any electronic device capable of virtualizing the scene of a dresser trying on a sample garment prototype or a sample garment, e.g., a virtual fitting mirror, virtual fitting glasses, or a virtual fitting helmet. Description will be given below to the embodiment of the present disclosure by only taking the virtual fitting mirror as an example. The modification unit 200 is configured to respond to user requirements, modify the sample garment prototype which is tried on by the dresser, and generate a sample garment satisfying the requirements of the dresser. The modification unit 200 may be implemented by software, hardware, firmware or other means.

The virtual fitting system provided by the embodiment provides sample garment prototypes for users (hereafter referred to as dressers) to select and try on, but the sample garment prototype is a virtual garment model, and the fitting is also virtual fitting, namely the scene of the dresser trying on the sample garment prototype will appear in the virtual fitting mirror when the dresser stands on front of the virtual fitting mirror. By virtual fitting, the dresser selects the sample garment prototype which is substantially satisfied by the dresser. If the dresser is not satisfied with the details of the sample garment prototype such as the collar type or pattern, the dresser may directly adopt the modification unit to modify the sample garment prototype which is tried on and generate the sample garment satisfying the requirements of the dresser, so that personalized customization can be achieved.

The virtual fitting mirror in the embodiment has display function and can virtualize the scene of the dresser trying on the sample garment prototype or the sample garment. No limitation will be given to the specific principles and structures.

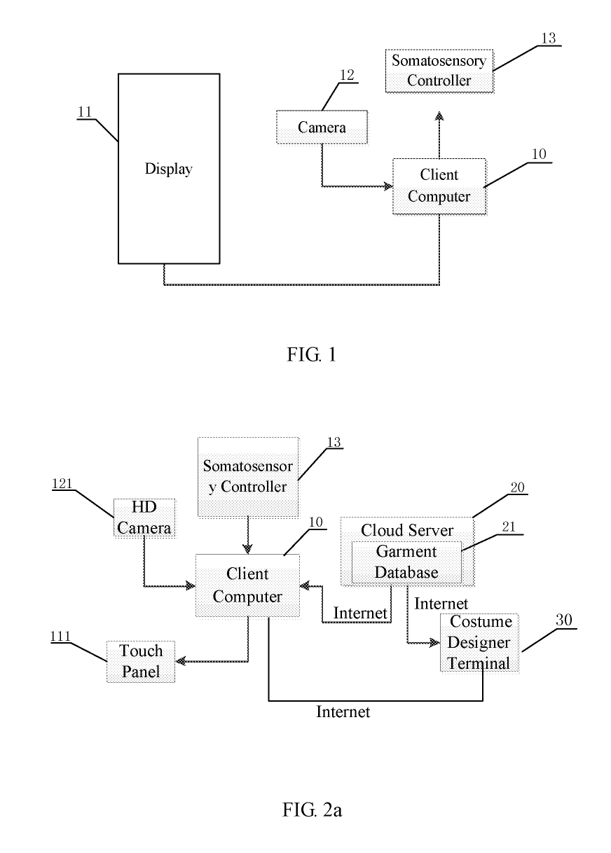

As illustrated in FIG. 1a, an optional virtual fitting mirror provided by the embodiment of the present disclosure comprises: a display 11, a camera 12 (e.g., an HD camera), a somatosensory controller 13 and a client computer 10. The camera 12, the somatosensory controller 13 and the display 11 are all connected with the client computer 10, for instance, by wireless or wired means. The camera 12 is configured to capture a body image of a dresser and transmit the body image to the client computer 10. The somatosensory controller 13 is configured to sense the figure of the dresser and transmit figure information of the dresser to the client computer 10. The client computer 10 is configured to perform image processing on the body image captured by the camera 12 and display the body image on the display 11, and is also configured to calculate the garment size adapted to the dresser according to the figure of the dresser, and match the sample garment selected by the dresser onto the body image according to the calculated garment size by image processing, and then the display 11 virtualizes the scene of the dresser trying on the selected garment. The calculation and image processing involved in the process may adopt a plurality of implementations in the prior art, e.g., image fusion technology. No limitation will be given here in the embodiment. The display 11 may also be replaced by other display devices, e.g., a projection display device.

As for the dresser, the display 11 in the embodiment is a visual part of the virtual fitting mirror and has the function of a common fitting mirror, but the usual dressing and undressing actions are not required. Optionally, the display 11 taken as the virtual fitting mirror may be a large-size (more than 55 inches) mirror display or an electronic whiteboard. In addition, optionally, a wardrobe may also be virtualized and used for providing the sample garment prototypes. In the absence of users, the virtual fitting system is in standby mode. When the user enters into a functional area on front of the virtual fitting mirror, the system prompts the user to select a favorite garment in the virtual wardrobe, and then the user can observe the virtual fitting effect on the virtual fitting mirror. Garments (e.g., the sample garment prototypes) in the virtual wardrobe may be respectively displayed according to gender, style and the like, so that rapid search and selection can be achieved. The dresser may also wear accessories. In addition, the size of the virtual garment put on by the dresser will automatically reveal different effects along with the figure of the dresser, which is just like the effect obtained when the dresser tries on actually. The virtual fitting system provided by the embodiment can save the trouble of dressing and undressing in the traditional fitting process, and save a lot of time, manpower and garment resources.

Optionally, the display 11 is a touch panel. e.g., a 40 inch or 65 inch HD (High Definition) touch panel. The display 11 is also configured to receive a modification instruction of the dresser on the sample garment prototype or the sample garment which is tried on. The dresser may directly select the sample garment prototype through the display 11, and input the modification instruction on the sample garment prototype or the sample garment which is tried on through the modification unit 200.

As shown in FIG. 2b, the virtual fitting system may further comprise: an online communication unit 300 used for online communication between the dresser and a costume designer. The online communication unit includes but not limited to an online communication tool such as QQ. On this basis, hardware of the virtual fitting system may also include: a microphone 700 connected with the client computer 10. The camera 12 and the microphone 700 are used for real-time communication with the costume designer. The dresser will communicate with the costume designer on the modification or other matching suggestions of the sample garment prototype which is tried on, and require the costume designer to modify the sample garment prototype or the sample garment.

Optionally, the modification unit 200 includes: an independent modification module 210 and a designer modification module 220. The dresser accesses a garment database 21 through the independent modification module, independently modifies a selected sample garment prototype within restricted permissions, and generates a sample garment satisfying the requirements of the dresser. The costume designer accesses the garment database 21 through the designer modification module, modifies a sample garment prototype selected by the dresser according to the requirements of the dresser, and generates a sample garment satisfying the requirements of the dresser. The dresser and the costume designer have different permissions on the modification of the sample garment prototype and also have different permissions on the access of the garment database. Moreover, the access and modification permissions of the costume designer may also be more finely classified and may also be set according to specific application conditions. No further description will be given here.

According to one example of the present disclosure, the garment database 21 includes: a sample garment prototype stock used for providing the sample garment prototypes for the users. The sample garment prototype includes clothing attributes. The clothing attributes are used for describing the sample garment prototype, for instance, may include style, material, collar type, sleeve type, hem type, pattern, decorative lace, etc. The sample garment prototype stock is used for providing the sample garment prototypes for the users and provides technical basis for modification.

The garment database 21 also includes: clothing attribute stocks relevant to the sample garment prototype stock. The clothing attribute stocks include a style stock, a material stock, a collar stock, a sleeve stock, a hem stock, a pattern stock, a lace stock and an accessory stock. The clothing attribute stocks provide selections for the user to modify the sample garment prototype, so that the modification can be simple and convenient. Each sample garment prototype in the sample garment prototype stock is relevant to the clothing attribute stocks via the clothing attributes. The modification unit 200 achieves the following functions by access to the sample garment prototype stock and the clothing attribute stocks: illustratively, if the dresser is not satisfied with the collar of a garment which is tried on, the dresser may click the collar and input a collar modification instruction, and the collar of the garment will automatically disappear; meanwhile, the background calls the clothing attribute stock of the sample garment prototype which is tried on in view of this, and a plurality of other collars appear for selection; and after the user selects, the size of the collar of the garment is automatically adjusted, so that the collar can be in accordance with the current garment and displayed.

Optionally, the virtual fitting system further comprises: a sample garment stock 400 configured to store sample garments which are generated by the modification of the users. For instance, the sample garment stock is also relevant to the clothing attribute stocks, so that twice or more modifications of the sample garment can be achieved.

Optionally, the virtual fitting system may further comprise: a modeling unit 500 configured to generate the sample garment prototype. Users having permissions, e.g., the costume designers, may generate or import sample garment models designed by themselves.

Optionally, the virtual fitting system may further comprise: an ordering unit 600 configured to generate an order including the attributes of the sample garment prototype or the sample garment which is tried on if the dresser is satisfied with the sample garment prototype or the sample garment which is tried on. The virtual fitting system provided by the embodiment includes a part for interactive communication between the dresser and the costume designer. Thus, the dresser may modify a certain attribute of the garment according to own thoughts in the fitting process, and communicate with the costume designer; the costume designer may modify the garment model according to the thoughts of the dresser; after the dresser is satisfied with the fitting effect, the dresser places an order with a garment factory through the ordering unit; and the garment factory makes the garment satisfying the requirements of the dresser according to drawings provided by the costume designer or the dresser, and mails the garment to the address listed by the dresser.

In the virtual fitting system provided by the embodiment of the present disclosure, the dresser not only can select the suitable garment by virtual fitting but also can modify a certain detail of the garment according to own thoughts and communicate with the costume designer; the costume designer modifies the garment model according to the thoughts of the dresser; after the dresser is satisfied with the fitting effect, the garment factory makes the garment satisfying the requirements of the dresser according to the drawings provided by the costume designer; and hence the personalized customization of clothes can be achieved.

In addition, the embodiment of the present disclosure further provides a remote virtual fitting method, which comprises: allowing a dresser to try on clothes on front of a virtual fitting mirror and select a favorite sample garment prototype; and contacting a costume designer to modify or independently modifying until the dresser is satisfied with the fitting effect, if the dresser is not satisfied with the details of the sample garment prototype which is selected and tried on currently. The dresser may be interactive and communicated with the costume designer, so that the personalized customization of clothes can be achieved.

If the dresser is satisfied with the sample garment prototype or the sample garment which is selected and tried on currently, an order including the attributes of the sample garment prototype or the sample garment which is tried on is generated. If the dresser is substantially satisfied with the sample garment prototype or the sample garment which is selected and tried on currently and is only unsatisfied with some details, the dresser contacts the costume designer to modify or independently modifies until the dresser is satisfied with the fitting effect.

Optionally, if the costume designer is not online or the dresser selects independent modification, the dresser modifies the attributes of the sample garment prototype which is selected and tried on currently within restricted permissions, until the dresser is satisfied with the fitting effect; and if the costume designer is online and the dresser does not select independent modification, the dresser directly provides requirements to the costume designer by online communication, and the costume designer modifies the attributes of the sample garment prototype which is tried on currently, until the dresser is satisfied with the fitting effect.

In the virtual fitting method provided by the present disclosure, the dresser tries on the sample garment prototype provided by the virtual fitting mirror fitting system at first; and if the dresser is only unsatisfied with some details of the sample garment prototype which is selected and tried on currently, the dresser contacts the costume designer to modify or independently modifies through the modification unit, until the dresser is satisfied with the fitting effect, so that the personalized customization of clothes can be achieved. Therefore, the dresser may modify a certain attribute of the garment according to own thoughts in the fitting process, and communicate with the costume designer; the costume designer modifies the garment model according to the thoughts of the dresser; and after the dresser is satisfied with the fitting effect, the garment factory makes the garment satisfying the requirements of the dresser according to drawings provided by the costume designer.

### Second Embodiment

For more clear understanding of the virtual fitting system and method provided by the embodiment of the present disclosure, detailed description will be given below to the technical proposals of the present disclosure with reference to the preferred embodiments.

FIG. 2a is a structural block diagram of a virtual fitting system provided by the second embodiment of the present disclosure. As illustrated in FIG. 2a, the embodiment provides a virtual fitting system, which comprises a high-performance client computer 10, and a touch panel 111, an HD camera 121 and a somatosensory controller 13 which are connected with the client computer 10. The touch panel 111, for instance, may be an ultra HD 65 inch touch panel and has the function similar to a fitting mirror. The HD camera 121 displays a captured body image on the touch panel 111 after the image is processed by the client computer. The somatosensory controller 13 is configured to sense the figure of the dresser and transmit figure information to the client computer 10. The client computer 10 is configured to calculate the suitable garment size according to the figure of the dresser, and allow the dresser to virtually “put on” the garment, so as to achieve the function of a virtual fitting mirror.

The client computer 10 is connected with a costume designer terminal 30 (namely a design computer of a costume designer) via Internet. When the dresser modifies the garment on the touch panel 111, modified data are processed by the client computer, and the data are transmitted to the costume designer terminal 30 in real time via Internet. The other means is that the functions of the HD camera 121 and a microphone 700 are combined, and acquired image information and microphone information are processed by the client computer, so that real-time communication with the costume designer, namely video call, can be achieved.

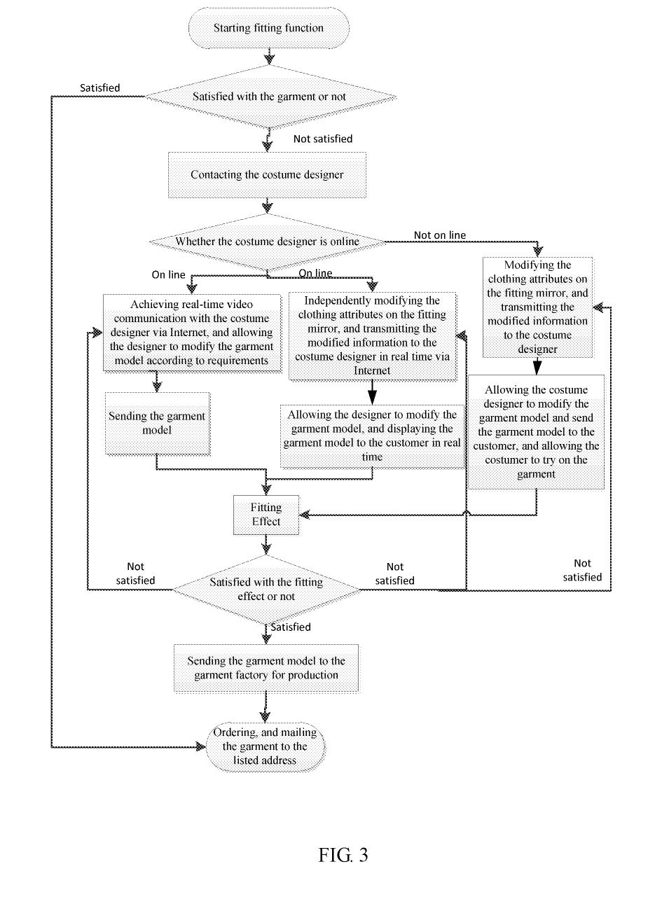

FIG. 3 is a flowchart illustrating the real-time communication between the dresser and the costume designer. The fitting function is started, and the dresser tries on clothes on front of the virtual fitting mirror. If the dresser is satisfied with the currently selected garment, the dresser directly orders and purchases the garment. If the dresser is not satisfied with some details of the currently selected garment, the dresser needs to contact the costume designer to modify:

(1) If the costume designer is not online, the dresser may independently modify wanted style on the virtual fitting mirror; after storage, the virtual fitting system transmits a garment to be modified to the costume designer; the garment is modified by the costume designer according to requirements and subsequently transmitted to the dresser via the network of the virtual fitting mirror; the dresser tries on the garment on the virtual fitting mirror; if satisfied, the dresser sends the garment to the garment factory for production; and the garment is produced and mailed to the address listed by the dresser.

(2) If the costume designer is online, real-time communication can be achieved.

One means is that real-time video communication with the costume designer is achieved via Internet; the costume designer modifies the garment model according to oral requirements of the dresser, sends the garment model to the dresser for fitting after the garment model is modified, until the dresser is satisfied with the fitting effect, and subsequently, send the final draft to the garment factory for production; and the produced garment is mailed to the address listed by the dresser.

Another means is that the dresser independently modifies the clothing attributes on the virtual fitting mirror; the modified garment is displayed on a computer of the costume designer in real time via Internet; the costume designer generates a garment model according to the modified garment, sends the garment model to the dresser for fitting in real time, until the dresser is satisfied with the fitting effect, and finally, send the garment model to the garment factory for production; and the produced garment is mailed to the address listed by the dresser.

The costume designer creates a garment database 21 simultaneously when designing clothes, and the garment database 21 may be disposed on a cloud server 20 and may also disposed on the costume designer terminal 30. The garment database 21 includes clothing attribute stocks, a modifiable garment stock and an unmodified garment stock. The clothing attribute stock includes a collar stock, a sleeve stock, a hem stock, a style stock and a pattern stock. The modifiable garment stock is divided into a partial modification stock and a full modification stock. Clothes in the unmodified stock are fixed and cannot be modified unless the designer is online.

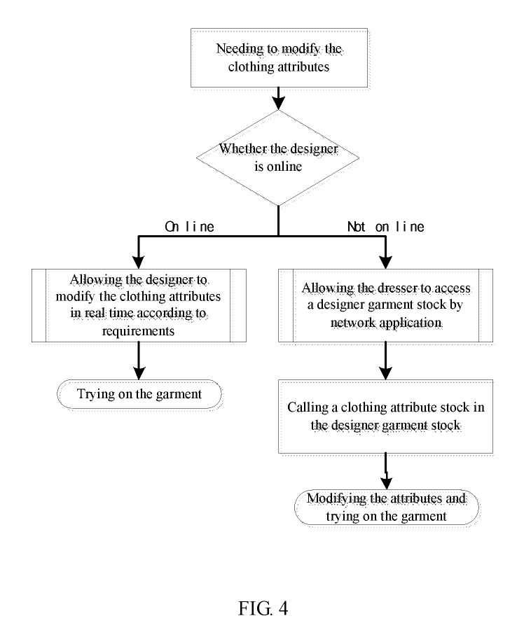

FIG. 4 is a flowchart illustrating the process of modifying the clothing attributes involved in the above process. When the clothing attributes are required for modification, the following circumstances are provided.

When the costume designer is online, real-time communication may be achieved. The dresser directly provides own requirements to the designer by video and large-data real-time transmission; the designer modifies the clothing attributes; and the garment is transmitted in real time to the dresser for fitting. The dresser may also independently modify the clothing attributes on the fitting mirror and transmit the modified information to the costume designer by large-data real-time transmission; and the costume designer modifies the clothing attributes onto a sample garment, and provides the sample garment for the dresser to try on.

When the costume designer is not online, the dresser may modify a garment in the garment stock, and simultaneously, the clothing attribute stocks for the access of the dresser are opened. The dresser opens an access account and accesses the clothing attribute stocks of the costume designer via Internet. The clothing attribute stocks can only be modified and updated by the costume designer. As for the dresser, only the call function can be accessed, and the modification of the garment by the dresser has no impact on the initial sample garment prototype.

When the dresser needs to modify the clothing attributes in the modifiable garment stock, the following methods may also be adopted: firstly, creating a partial modification stock. As for the clothes in the stock, only one attribute or several attributes can be modified, but the clothes are unchanged on the whole. If the client wants to observe the fitting effect of the clothes in real time, the designer needs to create a user stock in the process of designing clothes. The stock includes modifiable attributes of each garment, and the modifiable attribute of the garment is an independent, individual, replaceable attribute. When the user modifies the garment, the attributes in the user stock are called: (1) in the process of modifying the collar, if a round collar must be modified into other collars, when the collar stock is selected, the collar of the garment must automatically disappear, and other collars such as V collar in the clothing attribute stock of the costume designer are called; and the size of the garment collar is automatically adjusted, so that the collar can be in accordance with the current garment; (2) in the process of modifying sleeves of the garment, e.g., converting long sleeve into short sleeve, rolling up the long sleeve a little, converting long sleeve into sleeveless state, converting into flounce sleeve, or converting into bubble sleeve, the sleeve stock is clicked; the garment sleeve automatically disappears; and suitable sleeve is found out and matches with the current garment into a whole; (3) in the process of modifying the hem of the garment, the hem stock is clicked; the hem automatically disappears; modifiable hems in the user stock are called one by one for fitting and comparison; and a suitable hem is selected; and (4) in the process of modifying the pattern on the garment, the designer may recommend several patterns with innovative design in the user stock, and the user may also independently design by giving free rein to his or her imagination. In addition, in the process of modifying the garment, all the modifiable attributes have no color, and the color may be adjusted by the users. Other exposed parts of the garment in the modifying process may be wiped off, and the modified garment is sent to the costume designer by Save As command after modification.

Secondly, creating a full modification stock. The garment in the stock has no specific form; only the frame of the garment is provided, but the style of the garment may be adjusted; and the garment types such as H type, A type, T type, V type, X type and O type may be stored in the user stock. Various attributes in the clothing attribute stocks are called for type matching, and the color, the size and the like of the clothing attributes are modified to finally match the wanted garment type. It should be noted that the clothing attributes in the partial modification stock may be shared in the full modification stock.

The virtual fitting system provided by the embodiment of the present disclosure further comprises a modification unit 200 configured to respond to the requirements of the user, achieve the modification of the dresser on the sample garment prototype which is tried on, and generate the sample garment satisfying the requirements of the dresser. The modification unit includes: an independent modification module 210 and a designer modification module 220. The independent modification module is adopted by the dresser to access a garment database, independently modify a selected sample garment prototype within restricted permissions, and generate a sample garment satisfying the requirement of the dresser. The designer modification module is adopted by the costume designer to access the garment database, modify a sample garment prototype selected by the dresser, and generate a sample garment satisfying the requirement of the dresser. The modification unit and the independent modification module and the designer modification module in the modification unit may be implemented by software, are disposed on the cloud server together with the garment database, and of course, may be installed on the client computer and the costume designer terminal by program download or other means. No limitation will be given in the embodiment.

In the virtual fitting system and method provided by the embodiment of the present disclosure, the dresser may modify a certain attribute of the garment according to own thoughts in the fitting process, and communicate with the costume designer; the costume designer modifies the garment model according to the thoughts of the dresser; and after the dresser is satisfied with the fitting effect, the garment factory makes the garment satisfying the requirements of the dresser according to drawings provided by the costume designer.

In the virtual fitting system and method provided by the present disclosure, the dresser tries on the sample garment prototype provided by the virtual fitting mirror fitting system at first; and if the dresser is only unsatisfied with some details of the sample garment prototype which is selected and tried on currently, the dresser contacts the costume designer to modify or independently modifies through the modification unit, until the dresser is satisfied with the fitting effect, so that the personalized customization of clothes can be achieved.

For clear description, the words such as first and second are adopted in the present disclosure to distinguish similar items; the words first and second are not intended to limit the present disclosure in number and are only intended to illustrate the preferred embodiments. Obvious similar deformations or relevant expansions which are thought of by those skilled in the art on the basis of the content of the present disclosure shall all fall within the scope of protection of the present disclosure.

The embodiments in the description are all described in a progressive manner; same and similar parts of the embodiments may refer to each other; and each embodiment emphasizes those different from other embodiments. Particularly, as device embodiments are basically similar to method embodiments, the device embodiments are simply described and relevant parts may refer to partial description of the method embodiments.

It should be understood by those skilled in the art that all or partial processes in the method provided by the embodiment may be completed by adoption of a computer program to instruct relevant hardware; the program may be stored in a computer-readable storage medium; and the program may include the processes of the embodiments of the methods when executed. Wherein, the storage medium may be a magnetic disc, a CD, a read-only memory (ROM), a random access memory (RAM), etc.

What are described above is related to the illustrative embodiments of the disclosure only and not limitative to the scope of the disclosure. Obvious variations and replacement by any one of the skilled person in the art in the technical scope of the disclosure should be all covered in the scope of this disclosure. The scopes of the disclosure are defined by the accompanying claims.

The application claims priority to the Chinese patent application No. 201510595441.5, filed Sep. 17, 2015, the disclosure of which is incorporated herein by reference as part of the application.

1. A virtual fitting system, comprising:
a virtual fitting device configured to virtualize the scene of a dresser trying on a sample garment prototype or a sample garment; and
a modification unit configured to respond to requirements of the dresser, modify the sample garment prototype which is tried on by the dresser, and generate a sample garment satisfying the requirements of the dresser.

2. The virtual fitting system according to claim 1, further comprising: an online communication used for online communication between the dresser and a costume designer.

3. The system according to claim 1, wherein the modification unit includes: an independent modification module and a designer modification module;
the independent modification module is configured to access a garment database according to an input requirement of the dresser, independently modify a selected sample garment prototype within restricted permissions, and generate a sample garment satisfying the requirement of the dresser; and
the designer modification module is configured to access the garment database according to an input requirement of the costume designer, modify a sample garment prototype selected by the dresser, and generate a sample garment satisfying the requirement of the dresser.

4. The virtual fitting system according to claim 3, wherein the garment database includes:
a sample garment prototype stock configured to provide the sample garment prototype for the dresser or the costume designer; and the sample garment prototype includes clothing attributes.

5. The virtual fitting system according to claim 4, wherein the garment database further includes:
clothing attribute stocks being relevant to the sample garment prototype stock and including a style stock, a material stock, a collar stock, a sleeve stock, a hem stock, a pattern stock or a lace stock.

6. The virtual fitting system according to claim 4, further comprising:
a sample garment stock configured to store the sample garment generated by the modification of the dresser.

7. The virtual fitting system according to claim 6, wherein
the sample garment stock is relevant to the clothing attributes stocks.

8. The virtual fitting system according to claim 1, further comprising:
a modeling unit configured to generate the sample garment prototype.

9. The virtual fitting system according to claim 1, further comprising:
an ordering unit configured to generate an order including the sample garment prototype or the sample garment which is tried on.

10. The virtual fitting system according to claim 1, wherein the virtual fitting device includes a display device, in which
the display device is connected with a client computer and configured to display the scene of the dresser trying on the selected garment according to input of the client computer.

11. The virtual fitting system according to 10, wherein the virtual fitting device further includes a camera, a somatosensory unit and a client computer, in which both the camera and the somatosensory unit are connected with the client computer;
the camera is configured to capture a body image of the dresser and transmit the body image to the client computer;
the somatosensory unit is configured to sense the figure of the dresser and transmit figure information of the dresser to the client computer; and
the client computer is configured to perform image processing on the body image captured by the camera, display the body image on the display device, calculate the garment size adapted to the dresser according to the figure of the dresser, match the sample garment selected by the dresser onto the body image according to the calculated garment size by image processing, and send to the display device for display.

12. The virtual fitting system according to 10, wherein the display device is a touch panel and is also configured to receive a modification instruction of the dresser on the sample garment prototype or the sample garment which is tried on, and display obtained information according to the modification instruction.

13. The virtual fitting system according to claim 10, wherein the display device is a 65 inch high definition (HD) touch panel.

14. The virtual fitting system according to claim 2, further comprising: a microphone, wherein
the microphone is connected with the client computer and configured to input voice in the real-time communication with the costume designer.

15. The virtual fitting system according to claim 1, wherein the virtual fitting device includes a virtual fitting mirror.

16. A virtual fitting device, comprising: a display device and a client computer, wherein
the display device is connected with the client computer;
the client computer is configured to respond to user input and send information to the display device; and
the display device is configured to display the scene of a dresser trying on a selected garment according to the information sent by the client computer.

17. The virtual fitting device according to claim 16, further comprising: a camera and a somatosensory unit, wherein
both the camera and the somatosensory unit are connected with the client computer;
the camera is configured to capture a body image of the dresser and transmit the body image to the client computer;
the somatosensory unit is configured to sense the figure of the dresser and transmit figure information of the dresser to the client computer; and
the client computer is configured to perform image processing on the body image captured by the camera, display the body image on the display device, calculate the garment size adapted to the dresser according to the figure of the dresser, match the sample garment selected by the dresser onto the body image according to the calculated garment size by image processing, and send obtained information to the display device for display.

18. A remote virtual fitting method, comprising:
allowing a dresser to try on clothes on front of a virtual fitting mirror and select a favorite sample garment prototype; and
contacting a costume designer to modify or independently modifying until the dresser is satisfied with the fitting effect, if the dresser is not satisfied with the details of the sample garment prototype which is selected and tried on currently.

19. The method according to claim 18, wherein the step of contacting the costume designer to modify or independently modifying until the dresser is satisfied with the fitting effect, if the dresser is not satisfied with the details of the sample garment prototype which is selected and tried on currently includes:
if the costume designer is not online or the dresser selects independent modification, allowing the dresser to modify the attributes of the sample garment prototype which is selected and tried on currently within restricted permissions, until the dresser is satisfied with the fitting effect; and
if the costume designer is online and the dresser does not select independent modification, allowing the dresser to directly provide requirements to the costume designer by online communication, and allowing the costume designer to modify the attributes of the sample garment prototype which is tried on currently, until the dresser is satisfied with the fitting effect.

20. The method according to claim 18, further comprising:
generating an order including the attributes of the sample garment prototype or the sample garment which is tried on, if the dresser is satisfied with the sample garment prototype or the sample garment which is selected and tried on currently.
